(19) United States
(12) Patent Application Publication
(10) Pub. No.: US 2008/0184526 A1
(43) Pub. Date: Aug. 7, 2008

(54) Method for manufacturing table accessories and handles for cutlery, kitchen utensils and the like

(75) Inventor: Vigilio Bugatti, Lumezzane (IT)

Correspondence Address: MODIANO & ASSOCIATI, Via Meravigli, 16, MILANO, 20123, omitted

(73) Assignee: LA SAN MARCO DI FRANCESCO BUGATTI & C.S.A.P.A.

(21) Appl. No.: 11/987,689

(22) Filed: Dec. 4, 2007

(30) Foreign Application Priority Data
Feb. 6, 2007 (IT) MI2007A000208

(51) Int. Cl. A47G 21/00; B29D 31/00; B29C 59/16; B29C 55/26

(52) U.S. Cl. 16/110.1; 264/232; 264/400

(57) ABSTRACT

A method for manufacturing table accessories comprising the steps of obtaining from a sheet-like element made of plastics portions whose dimensions are consistent with a table accessory being provided, removing material at outer edges and in at at least one region of an internal surface to provide a profile of the table accessory and at least one internal pattern, and providing a surface finishing.

### BACKGROUND OF THE INVENTION

The present invention relates to a method for manufacturing table accessories and handles for cutlery, kitchen utensils and the like.

As is known, several kinds of kitchen accessories, cutlery handles, kitchen utensils and the like are currently commercially available which generally speaking are provided by molding plastics, which allows to provide shapes which can vary in each instance and necessarily entail the provision of a specific mold for each shape.

Another typical feature of known solutions consists in that the coloring of the handles or accessories provided by molding is influenced greatly by the type of treatment, and therefore it is not possible to have surfaces with patterns which in each instance can be selected as a function of market requirements.

### SUMMARY OF THE INVENTION

The aim of the invention is to solve the problem described above by providing a method for providing table accessories and handles for cutlery, kitchen utensils and the like which allows to assume innovative shapes, obtaining contours which in each instance can vary without thereby having to proceed with the provision of specific molds.

Within this aim, an object of the invention is to provide a method in which it is possible to vary at will the aesthetics of the surface without thereby having to resort to complex treatments.

Another object of the present invention is to provide a method for manufacturing table accessories and handles for cutlery, kitchen utensils and the like which can be performed easily starting from commonly commercially available elements and materials and is further competitive from a merely economical standpoint.

This aim and these and other objects, which will become better apparent hereinafter, are achieved by a method for manufacturing table accessories, characterized in that it consists in obtaining, from a sheet-like element made of plastics, portions whose dimensions are consistent with those of the table accessory being worked, in removing material at the outer edges and at at least one region of the internal surface to provide the profile of the table accessory and at least one internal pattern, and in performing surface finishing.

### BRIEF DESCRIPTION OF THE DRAWINGS

Further characteristics and advantages will become better apparent from the description of a preferred but not exclusive embodiment of a method for manufacturing table accessories and handles for cutlery, kitchen utensils and the like, illustrated by way of non-limiting example in the accompanying drawings, wherein:

FIG. 1 is a schematic perspective view of a sheet-like element made of plastics;

FIG. 2 is a schematic view of a possible embodiment of a portion whose dimensions are consistent with the product being manufactured;

FIG. 3 illustrates the shaping step to obtain the handle of a piece of cutlery and the like;

FIG. 4 is a view of the step for the surface finishing of the portion;

FIG. 5 is a sectional view of the step for providing a slot at the end of the handle;

FIG. 6 is a view of the step for the insertion of a piece of cutlery and the like;

FIG. 7 is a perspective view of a possible embodiment of a piece of cutlery with the handle obtained by means of the method according to the invention;

FIG. 8 is a schematic view of a table accessory of the coaster type obtained with the method according to the invention.

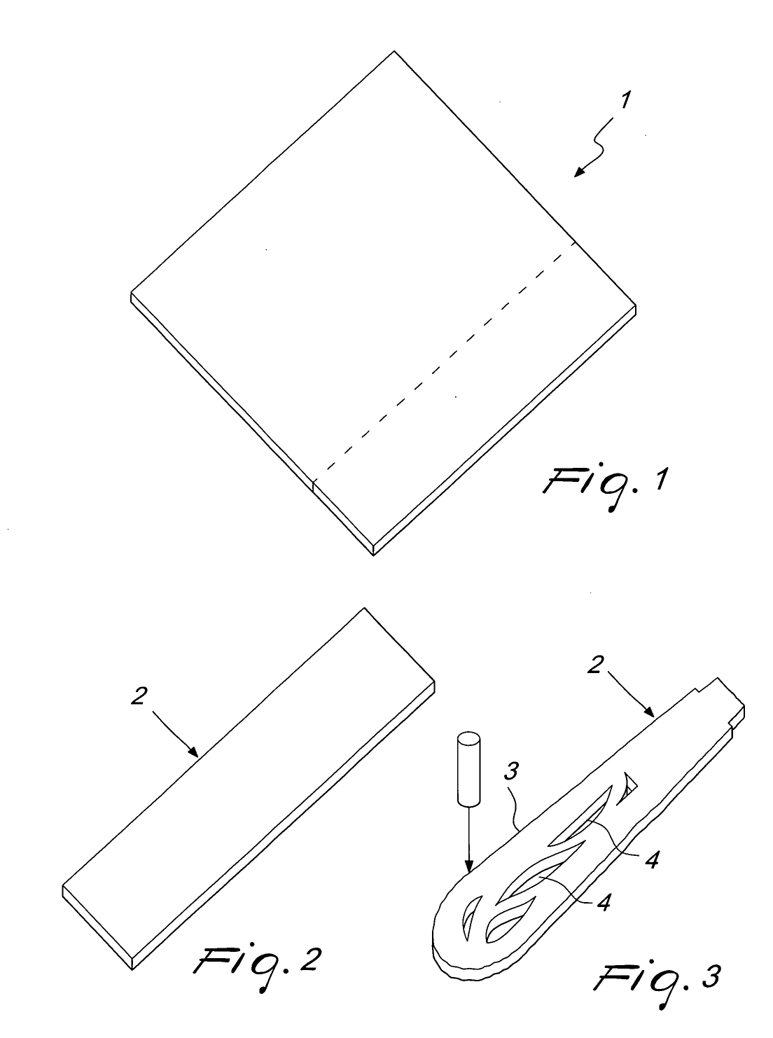

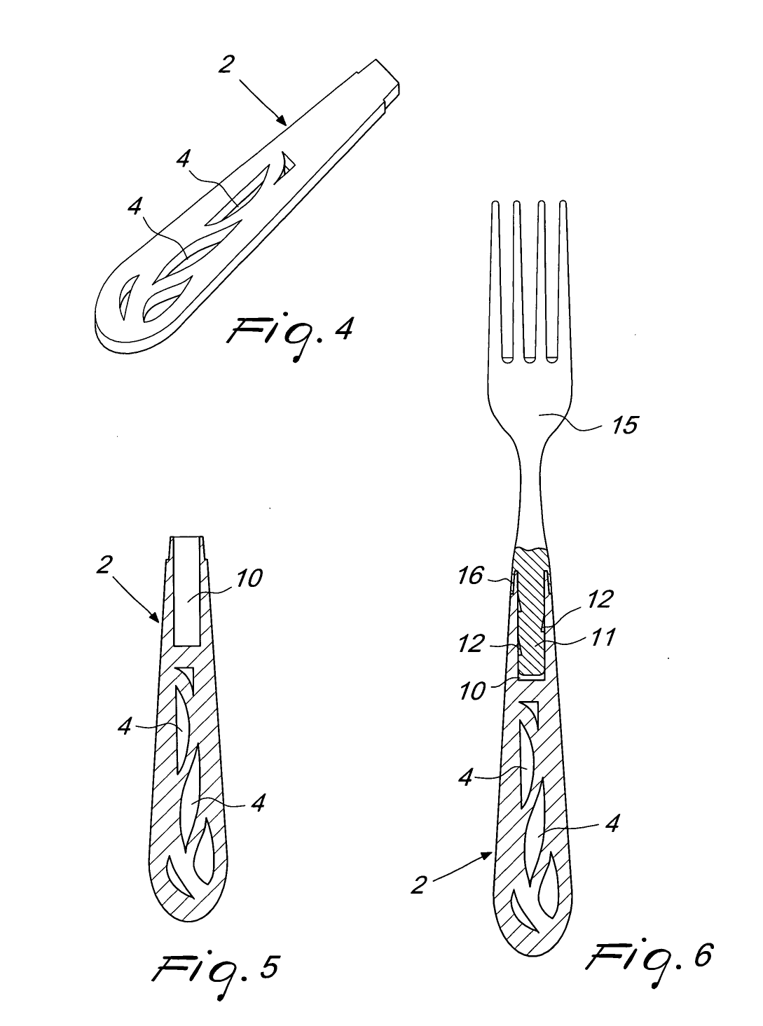

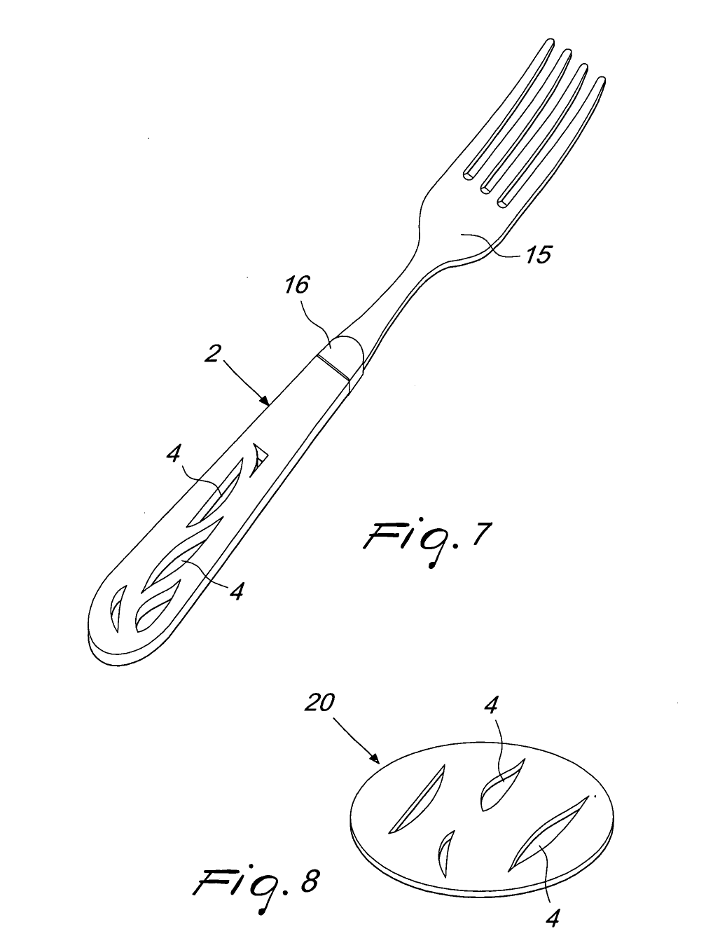

### DESCRIPTION OF THE PREFERRED EMBODIMENTS

With reference to the figures, the method for manufacturing table accessories and handles for cutlery, kitchen utensils and the like provides for the arrangement of a sheet-like element, generally designated by the reference numeral 1, which is advantageously made of plastics and is constituted preferably by a neutral transparent material, such as methacrylate, galalite and other plastic materials in sheet form, a material which can be mixed with different colors, so as to obtain a colored sheet which has veins with effect and shades which can vary in each instance.

Once the sheet-like element 1 has been prepared, portions designated by the reference numeral 2 are provided whose dimensions are consistent with the type of final product to be obtained.

Typically, in the case of the provision of a handle for a piece of cutlery, the portion 2 is approximately rectangular and elongated.

The subsequent step provides for a removal of material at outer edges 3 of the portion 2, thus obtaining the peripheral profile required for the handle.

Moreover, holes, designated by the reference numeral 4, are provided in the region of the internal surface so as to obtain the patterns deemed appropriate.

Of course, the number and type of the holes may be changed in any manner as a function of the contingent requirements.

Removal of the material can be performed by means of a laser beam which in practice performs cutting or optionally by means of mechanical milling operations.

Once the contour of the handle has been prepared, a step of surface finishing is performed which is provided advantageously by means of vibrating tumblers or other devices which allow, with the addition of optional finishing products, to obtain for example a glossy finish or in any case a surface which is pleasant to the touch.

In the case of the provision of a handle, a slot 10 is further provided at one end and a shank 11 is inserted therein according to a typical process by heating together with adhesive and is provided internally with sets of teeth which engage the walls of the slot, which advantageously is slightly smaller than the shank.

The shank is connected to a piece of cutlery, generally designated by the reference numeral 15, and advantageously has a collar or ring 16 which acts as a covering element for the terminal connecting region between the handle and the shank of the piece of cutlery.

If it is necessary to provide table accessories, such as for example coasters for glasses or bottles, generally designated by the reference numeral 20 in FIG. 8, the steps previously outlined are provided, without performing the final step of obtaining the slot to insert the shank.

From what has been described above, it is therefore evident that the invention achieves the proposed aim and objects and in particular the fact is stressed that a method is provided which allows to obtain handles for pieces of cutlery or kitchen utensils and table accessories whose shape is absolutely innovative and which further can easily modify the aesthetic aspect without having to resort to changes to the molds but simply by modifying the contours which can be obtained by providing the external profiles and the perforations that provide the decorative pattern or design.

Moreover, it is possible, with great simplicity, to vary the surface appearance due to the fact that the sheet-like element can have veins or variegations of any kind.

The invention thus conceived is susceptible of numerous modifications and variations, all of which are within the scope of the appended claims.

All the details may further be replaced with other technically equivalent elements.

In practice, the materials used, so long as they are compatible with the specific use, as well as the contingent shapes and dimensions, may be any according to requirements.

The disclosures in Italian Patent Application No. MI2007A000208 from which this application claims priority are incorporated herein by reference.

What is claimed is:

1. A method for manufacturing table accessories, comprising the steps of obtaining, from a sheet-like element made of plastics portions whose dimensions are consistent with those of a table accessory being provided, removing material at outer edges and at at least one region of an internal surface to provide a profile of the table accessory and at least one internal pattern, and performing a surface finishing.

2. The method according to claim 1, wherein said removal of material is provided by means of a laser beam.

3. The method according to claim 1, wherein said removal of material is performed mechanically by milling.

4. The method according to claim 1, wherein said surface finishing is provided by vibration with the addition of finishing products.

5. The method according to claim 1, wherein said sheet-like element is made of methacrylate.

6. The method according to claim 1, wherein said sheet-like element is made of galalite.

7. The method according to claim 1, wherein said sheet-like element has additions of coloring material.

8. A method for manufacturing handles for pieces of cutlery, kitchen utensils and the like, comprising the steps of obtaining from a sheet-like element made of plastics portions whose dimensions are consistent with a handle for cutlery, kitchen utensils and the like, removing material at outer edges and in at at least one region of the internal surface to provide the profile of the handle and at least one internal pattern, providing a surface finishing and providing, at one end of said handle, a slot for the insertion of the engagement shank of cutlery, kitchen utensils and the like.

9. The method according to claim 8, wherein said removal of material is provided by means of a laser beam.

10. The method according to claim 8, wherein said removal of material is performed mechanically by milling.

11. The method according to claim 8, wherein said surface finishing is provided by vibration with the addition of finishing products.

12. The method according to claim 8, wherein said shank is inserted in said slot by hot forcing together with adhesive.

13. The method according to claim 8, wherein said sheet-like element is made of methacrylate.

14. The method according to claim 8, wherein said sheet-like element is made of galalite.

15. The method according to claim 8, wherein said sheet-like element has additions of coloring material.

16. A table accessory, provided by means of the method according to claim 1.

17. A handle for cutlery, kitchen utensils and the like, provided by means of a method according to claim 1.

18. A table accessory, provided by means of the method according to claim 8.

19. A handle for cutlery, kitchen utensils and the like, provided by means of a method according to claim 8.
